(19) United States
(12) Patent Application Publication
(10) Pub. No.: US 2026/0027597 A1
(43) Pub. Date: Jan. 29, 2026

(54) TANK CLEANING ARRANGEMENT

(71) Applicant: B/E Aerospace, Inc., Winston Salem, NC (US)

(72) Inventors: Lukasz Turek, Wroclaw (PL); Piotr Jacek Kroczek, Nieciszow (PL); Krzysztof Slomiany, Jerzmanowice (PL); Pawel Jerzy Swirniak, Wroclaw (PL); Piotr Pawel Mroczkowski, Wroclaw (PL)

(73) Assignee: B/E Aerospace, Inc., Winston Salem, NC (US)

(21) Appl. No.: 19/271,581

(22) Filed: Jul. 16, 2025

(30) Foreign Application Priority Data
Jul. 26, 2024 (EP) 24461601

(51) Int. Cl. B08B 7/02; B08B 9/08

(52) U.S. Cl. CPC B08B 7/02; B08B 9/0817; B08B 2209/08

(57) ABSTRACT

A cleaning arrangement for cleaning an interior volume of a tank, the cleaning arrangement comprising an unbalanced mass device configured to be mounted to the tank, in use, to create an unbalanced mass acting on the tank to cause vibration of the tank.

### CROSS-REFERENCE TO RELATED APPLICATIONS

This application claims priority to EP patent application Ser. No. 24/461,601.7, filed Jul. 26, 2024 and titled “TANK CLEANING ARRANGEMENT,” which is incorporated by reference herein in its entirety for all purposes.

### FIELD

The present disclosure relates to ways of cleaning the interior of a tank such as, but not exclusively, a waste tank e.g. in an aircraft.

### BACKGROUND

Tanks or reservoirs containing matter such as waste from a sanitation system, or other matter, which may be contaminated or hazardous or generally undesirable if left on the inner surfaces of the tank for a period of time often include a device that extends into and sprays water or some cleaning fluid around the tank to clean the tank. This can avoid the need for manual cleaning of the tank which can be unpleasant or even dangerous. Furthermore, the tanks are often too small to enable a person to access the interior to clean it properly, or the tank may be vacuum sealed and so not accessible for manual cleaning and/or access to the tanks may be too difficult for the tank to be cleaned by a person. Passenger aircraft include large tanks for human waste from the aircraft toilets. These tanks are emptied after a flight and the inside of the tank is cleaned. This is usually done by means of a device, known as a rinse nipple, having nozzles through which pressurized water or a cleaning solution is sprayed around the interior of the tank.

A conventional rinse nipple includes a housing part to which a rinse hose providing the cleaning fluid is connected. The housing extends through the tank wall. A rinse head is provided at the end of the housing located inside the tank. The rinse head is provided with multiple openings or nozzles and the pressurized fluid is ejected out through the nozzles to clean the tank. Some rinse nipples have a rotatable rinse head. To avoid the need for power to be supplied to rotate the rinse head, the openings or nozzles are angled and offset relative to the axis of rotation of the head. This positioning provides momentum about the axis to cause the head to spin about the axis thus maximizing the coverage of the fluid inside the tank.

Whilst the multiple nozzles and spinning head ensures that the fluid is sprayed as much as possible around the tank interior, due to the presence of various components and fittings that may be provided on the tank walls, extending to the tank interior, there may be some areas that are effectively obstructed or hidden by these components and are not reached by the spray from the spinning head. Furthermore, particularly when the tanks are large. The fluid may not reach the bottom of the tank, or may not reach the bottom with sufficient force to provide effective cleaning. This can result in waste material or the like remaining in those areas where the pressurized fluid does not reach, and clogging or building up. The tank cannot, therefore, be fully purged of all of the waste, which can cause contamination of the tank. Furthermore, precision is required to assemble the rinse nozzle to the tank and there are restrictions on where the rinse nozzle can be mounted to the tank. For best cleaning, the rinse device needs to be as high as possible in or on the tank. Also, the nozzles of the rinse device can become blocked or clogged. There is, therefore, a need for a cleaning arrangement that can ensure that a greater area of the tank interior is contacted by the cleaning fluid using a simple and reliable assembly.

### SUMMARY

According to the present disclosure, there is provided a cleaning arrangement for cleaning an interior volume of a tank, the arrangement comprising: a device configured to be mounted to the tank, to create an unbalanced mass acting on the tank to cause vibration of the tank.

In one arrangement, the device comprises a ball mounted in a trace configured to fit around the tank, the ball configured to rotate around the trace to cause vibration of the tank.

In another arrangement, the device comprises an electric motor mounted to a trace configured to fit around the tank, the electric motor configured to move around the trace to cause vibration of the tank.

Other forms of unbalanced mass which move relative to the tank and cause vibration of the tank by such relative movement are also possible.

A tank including such arrangements, and a cleaning method are also provided.

### BRIEF DESCRIPTION OF THE DRAWINGS

Examples of the cleaning arrangement according to this disclosure will be described with reference to the drawings. It should be noted that these are merely examples and variations are possible within the scope of the claims.

FIG. 1 shows an example of a known tank and rinse arrangement for the purposes of explanation.

FIG. 2 is shown to explain a problem of the known device such as shown in FIG. 1.

FIG. 3 shows an example of a tank to which one example of a cleaning arrangement according to the disclosure is applied.

FIG. 4 shows an example of a tank to which another example of a cleaning arrangement according to the disclosure is applied.

FIG. 5A is a physical model of a typical suspension system to explain the operation of a cleaning arrangement according to the disclosure.

FIG. 5B shows equations of motion for an unbalanced mass and is a graphical representation of vibrations caused by a cleaning arrangement according to the disclosure.

FIGS. 6A, 6, 6C and 6D are shown to illustrate a tank having a cleaning arrangement such as shown in FIG. 3 at different stages of operation of the cleaning arrangement.

### DETAILED DESCRIPTION

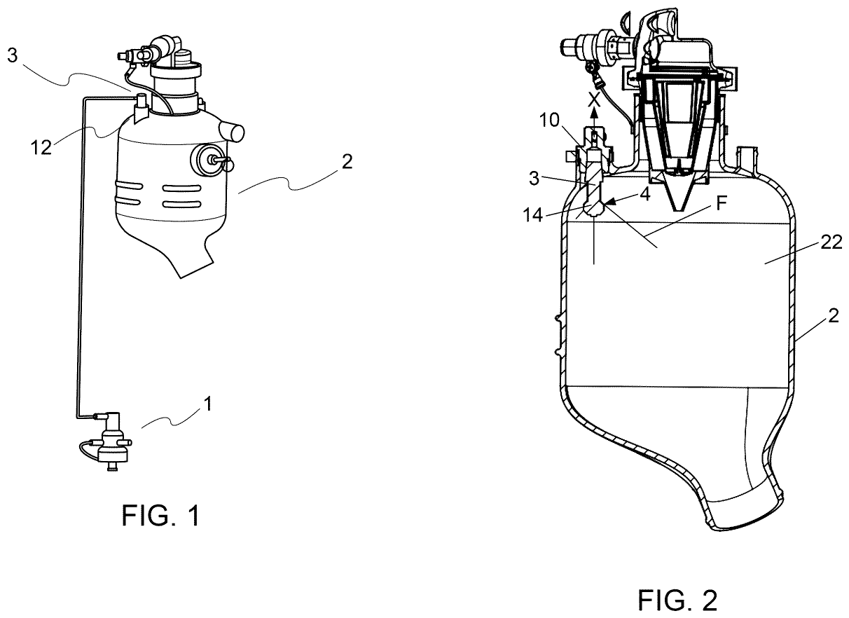

A typical rinse device is shown in FIGS. 1 and 2. A rinse nozzle 3 is shown mounted in the wall 12 of a tank 2 or vat or other reservoir. The rinse nozzle 3 is connected, in use, to a rinse port 1 from which rinse fluid is provided to the rinse nozzle from a rinse fluid supply (not shown). FIG. 2 shows, in cross-section, the rinse nozzle 3 mounted in the wall 12 of the tank 2, at the top of the tank. Apertures or jets 4 are formed in the nozzle 3 such that as rinse fluid is provided to the nozzle 3 it is sprayed out through the jets 4 around the interior 22 of the tank to clean the tank. A typical nozzle 3 comprises a housing 10, one end of which is provided with a fitting 13 arranged to be attached to a pipe or the like via which pressurized water or cleaning solution is provided. At the other end of the housing through which the pressurized fluid flows, which extends into the tank, is mounted a rinse head 14 mounted to rotate relative to the housing 10. The rinse head is arranged to rotate about an axis of rotation X which is the axis through the housing from the one end to the other end.

The rinse head 14 is provided with a number of holes or jets 4 via which the pressurized fluid F forced through the housing is ejected into the tank. The jets can be positioned offset from the axis of rotation and at angles such that the ejection of the pressurized fluid F provides a force that causes the rinse head 14 to rotate relative to the housing about the axis X.

The pressurization of the fluid and the rotation of the rinse head provides a good range of coverage of the interior of the tank with cleaning fluid. In some cases, however, areas may exist, due to the presence of other components on the inside of the tank, that fluid from the rinse head cannot reach. Alternatively, because the rinse nozzle is typically small and mounted into the top of the tank, the pressurized fluid F may not adequately reach the bottom or other locations in the interior of the tank, or at least not with sufficient force to adequately clean the tank. Furthermore, as can be seen in FIG. 2, the jets do not clean the tank in a symmetrical manner.

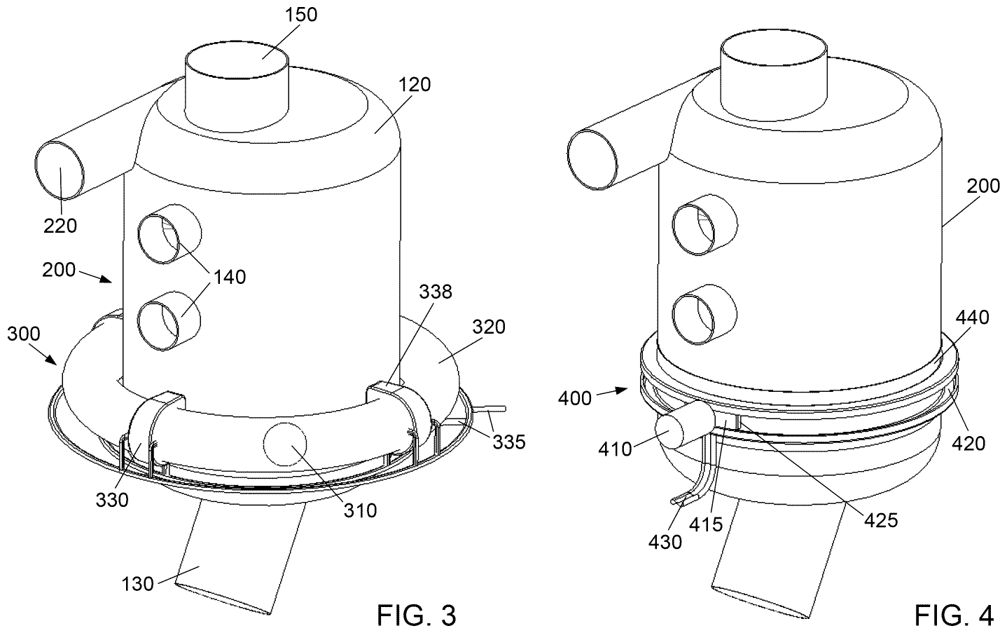

The cleaning arrangement according to this disclosure is designed to address these problems as will be described with reference to FIGS. 3 to 6. The arrangement will be described in relation to a tank similar to that shown in FIG. 1, for ease of explanation. It should be noted that the cleaning arrangement may be used with other types of tank of reservoir having an interior to be cleaned.

FIG. 3 shows an example of a tank 200 to which a cleaning arrangement according to this disclosure is mounted. The tank is of the conventional type such as shown ins FIGS. 1 and 2, the tank has a tank wall 120 defining the tank interior volume, a waste or other fluid inlet port 220 via which the tank contents e.g. waste, enter the tank and a drain port 130 via which the content exits the tank when the tank is emptied. In the example shown, level sensors 140 may be mounted to the tank. A vent port 150 may be provided at the top of the tank. Unlike the conventional cleaning arrangement described above, with the cleaning arrangement according to this disclosure, described further below, there is no need for a rinse port for a rinse nozzle in the tank wall.

Instead, the cleaning arrangement according to this disclosure comprises a device that attaches to the exterior of the tank and has an unbalanced mass that moves relative to the tank during the cleaning process to cause vibration of the tank and, consequently, sloshing of the contents of the tank. In use, therefore, to clean the tank, water or other cleaning fluid, including, if required, detergent or the like, is introduced into the tank via the standard fluid inlet port 220 which the tank already has for entry of the waste fluids into the tank. To clean the tank 200, the tank can be emptied of waste by opening the drain port 130 or in any other known way. It is not necessary that the tank is completely emptied of waste. Then, water/cleaning fluid is provided into the tank via the inlet port 220. The amount of water/cleaning fluid may vary according to the type of tank and its use and may range from an amount to partially fill the tank to an amount to substantially completely fill the tank.

The cleaning process comprises attaching the unbalanced mass device 300, 400 (described further below) to the exterior of the tank. In some examples, the device may be only attached to the tank when required to perform cleaning. In other examples, the device may remain attached to the tank even when not performing cleaning.

The unbalanced mass device extends at least partially around the body of the tank 200. In the examples shown, the device 300, 400 extends completely around the circumference of the tank body.

The unbalanced mass device 300, 400 comprises a mass 310, 410, 415 that moves relative to the tank 200 and a trace 320, 420 around which the mass moves. The device also comprises a drive 330, 335, 338; 430 to cause movement of the mass around the trace.

In one example, such as shown in FIG. 3, the mass is an electrically conductive ball 310 and the trace 320 is in the form of a tube or pipe through which the ball moves relative to the tank. The drive to move the ball comprises a plurality of wound coils 330 spaced around the trace to which electric power is provided e.g. from an external supply via power cables 335, and a sensor 338 (e.g. an infrared or inductive sensor) at or in each coil (330), which are also powered via power cables (the same cables as the coil or different cables). In the example shown, four coils are spaced 90 deg. apart around the circumference of the tank, but other numbers/spacing are also feasible.

In the example of FIG. 3, vibration of the tank and, hence, sloshing of the content around the tank interior, to clean the interior, is caused as follows. The conductive ball 310 rolls around the tube 320. When a sensor 338 detects that the ball is close to a coil 330, the coil is powered on by electric power from the power cables 335 which creates a field to draw the ball through the coil. Once the ball has passed through that coil, power is immediately switched off and the ball rolls through the tube towards the next coil due to the ball's inertia. As it approaches the next coil, the next sensor senses the approaching ball and switches that coil on to accelerate the ball through the coil, and so on. In this way, as the ball rotates around the tube, its acceleration increases and the more coils there are, the greater the acceleration (although this is a trade off with overall weight-more coils create more acceleration and so more vibration by add more weight to the overall arrangement). As the device is attached to or around the tank, as the mass (ball) moves relative to the tank, its mass causes the tank to move slightly towards the ball, wherever it is located in the tube. This causes vibration of the tank and causes the contents to slosh around the tank interior. The impact of the sloshing content on the tank interior cleans the interior, removing debris etc.

In another example, as shown in FIG. 4, instead of a conductive ball, the unbalanced mass device 400 comprises a track 420 in the form of a track and an electric engine 410 which moves around the track 420 on a runner with rollers 425. The electric engine 410 is connected by means of a shaft 415 and the runner 425 to the track. Electric power is provided to the track 420 e.g. via power cables 430, which transfers current to the engine 410 to drive the engine around the track. Because electric power is provided to the track, the tank may be isolated from the track by means of e.g. a dielectric layer or sleeve 440 that, in use, is located between the track and the tank.

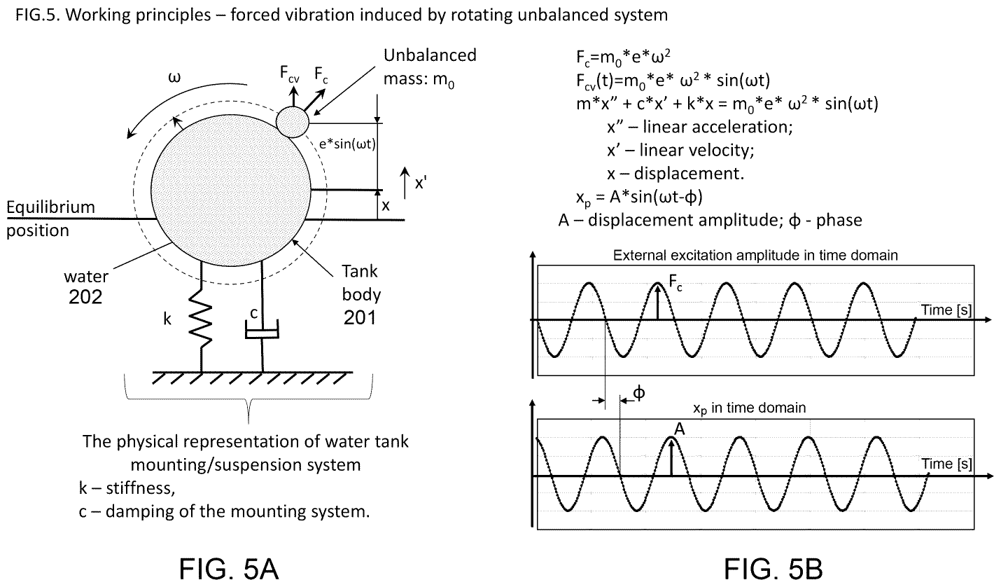

The working principles of the unbalanced mass are explained with reference to the model of FIG. 5A.

The tank 200 is defined by the tank body 201 and having a tank interior containing the water/cleaning fluid 202. The tank may be supported by a mounting system e.g. springs/slightly flexible supports/a dashpot with a damping coefficient c. The unbalanced mass 310,410 is subjected to a centrifugal force Fc acting towards the interior of the tank. The force amplitude can be described by the equation Fc=m0*e*ω2. The ‘v’ component of the centrifugal force Fcv(t) acts as external excitation Fcv(t)=m0*e*ω2 sin(ωt) for the tank filled with e.g. water 202. This creates a vibration system vibrating around the equilibrium position. This is due to the component sin(ωt) which can take any possible value between maximum Fc and minimum-Fc, including zero. The equation of motion for damped force vibrations of the unbalanced rotating system is m*x″+c*x′+k*x=m0*e*ω2 sin(ωt), where: x″=linear acceleration; x′=linear velocity and x=displacement. And the specific solution for this equation is xp=A*sin(ωt−Φ) where A=displacement amplitude and Φ=phase. A graphical representation of the vibrations based on these equations is shown in FIG. 5B. It should be noted that the vibrations can be controlled by many parameters and can be strong or weak.

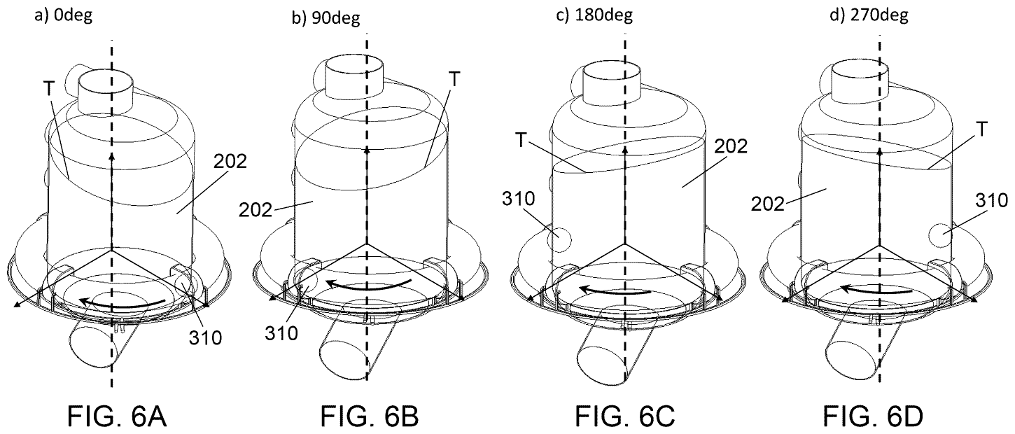

FIGS. 6A to 6D show an example of a cleaning arrangement according to the disclosure in use. The example shown here uses a conductive ball 310 as described above with reference to FIG. 3, but the operating principles apply to other examples.

In FIG. 6A, the ball 310 is at a first circumferential location in the tube 320 causing the unbalanced mass device and, hence, the tank to tilt slightly in the direction of the ball and so the top surface T of the water 202 is also tilted down towards the ball. The ball then rotates, as described above, around the tube to the next coil at a position shown in FIG. 6B. The shift in mass applied to the tank via the device/ball causes a shift in the tile of the surface T of the tank content. The ball then rotates further, to the position shown in FIG. 6C causing a further tilt in the water 202, and then to the position shown in FIG. 6D. The rotation of the mass, causing vibration of the tank, therefore, causes the content 202 of the tank to slosh around the interior of the tank. The velocity of the ball can be varied. Varying the velocity of the ball at different locations can also cause a reversal of the sloshing effect. The effect is that the content sloshes around the entire interior of the tank even if the tank is only partly filled with water/cleaning fluid, which can result in using less water/cleaning fluid than conventional systems using a rinse nozzle.

The arrangement according to this disclosure therefore provides a simple, effective, lightweight cleaning system that can be easily used with existing tanks without the need for structural modification of the tank. The arrangement is suitable for a wide range of tanks/other reservoirs including those made of metal and non-metallic materials. The arrangement provides effective and thorough cleaning of the entire interior of the tank and may use less water/cleaning fluid and/or detergent than conventional rinse nozzle systems.

1. A cleaning arrangement for cleaning the interior of a tank containing fluid, the cleaning arrangement comprising an unbalanced mass device configured to be mounted to the tank, in use, to create an unbalanced mass acting on the tank to cause vibration of the tank.

2. The cleaning arrangement of claim 1, wherein the unbalanced mass device includes an electrically conductive member and a track around which the electrically conductive member moves, the track configured to be mounted to extend at least partially around the tank, in use.

3. The cleaning arrangement of claim 2, further comprising a drive for causing movement of the electrically conductive member on the track.

4. The cleaning arrangement of claim 2, wherein the unbalanced mass device comprises an electrically conductive ball and the track is in the form of a tube within which the ball moves.

5. The cleaning arrangement of claim 4, wherein the track further comprises a plurality of electric coils spaced around the track, each coil having an associated sensor to detect the approach of the conductive ball to the coil and to trigger powering on of the coil to accelerate the ball therethrough and powering off of the coil once the ball has passed therethrough.

6. The cleaning arrangement of claim 1, wherein the unbalanced mass device comprises an electric engine and an electrically conductive track and a runner on which the electric engine rides along the track.

7. The cleaning arrangement of claim 6, further comprising rollers on the runner.

8. The cleaning arrangement of claim 6, further comprising electrical isolation arranged to be positioned between the conductive track and a tank to which the arrangement is mounted, in use.

9. The cleaning arrangement of claim 8, wherein the electrical isolation comprises a dielectric layer or sleeve.

10. The cleaning arrangement of claim 1, including power supply cables to provide power to the unbalanced mass device.

11. The cleaning arrangement of claim 1, wherein the unbalanced mass device is configured to extend around the entire circumference of the tank, in use.

12. The cleaning arrangement of claim 1, wherein the unbalanced mass device is configured to be mounted to a tank by means of a damped mounting system.

13. A tank defining an interior volume to be cleaned, the tank comprising the cleaning arrangement as claimed in claim 1 mounted to the exterior of the tank.

14. A method of cleaning an interior of a tank comprising:
mounting the cleaning arrangement as claimed in claim 1 to the tank, providing a cleaning fluid into the tank; and applying electrical power to the cleaning arrangement to cause vibration of the tank
